(19) United States
(12) Patent Application Publication
(10) Pub. No.: US 2026/0178846 A1
(43) Pub. Date: Jun. 25, 2026

(54) USING LLMS TO AUTOMATICALLY CREATE FOLLOW-UP LINKS IN LLM RESPONSE

(71) Applicant: GOOGLE LLC, Mountain View, CA (US)

(72) Inventor: Kevin Gaunt, Mountain View, CA (US)

(21) Appl. No.: 19/412,199

(22) Filed: Dec. 8, 2025

Related U.S. Application Data
(60) Provisional application No. 63/736,228, filed on Dec. 19, 2024.

(51) Int. Cl. G06F 40/40; G06F 40/289; G06N 3/0475

(52) U.S. Cl. CPC G06F 40/40; G06F 40/289; G06N 3/0475

(57) ABSTRACT

Implementations relate to generating a response for a user query using a generative model. The generative model can be fine-tuned to generate an LLM response for the user query in markup language. For example, the LLM response can include a predefined number of anchor tags each associated with a key phrase in the LLM response, where each anchor tag can identify a follow-up query determined based on a respective key phrase in the LLM response. Based on the LLM response, a final response in natural language can be rendered visually to a user of the user query, where the final response can have the key phrases in the LLM response highlighted. Further, when rendered, a key phrase can be selectable, and when selected by the user, causes a corresponding follow-up query to be processed using the fine-tuned generative model, to generate a further response to the follow-up query.

### BACKGROUND

Generative models such as large language models (“LLMs”) have been developed and used to process user input (e.g., typed or audible, etc.), to generate output from which content responsive to the user input is derived. For example, in response to receiving a user query from a user (e.g., via a user interface associated with the generative model), the generative model can be used to process the user query as input, to generate generative model output that reflects generative natural language (NL) content and/or other generative content (e.g., image, video, etc.) that is responsive to the user query. The user interface associated with the generative model can be, for instance, a graphical user interface (or an audible user interface) of a chat application, or a different application, that accesses the generative model. The generative NL content and/or other types of generative content can be rendered, visually and/or audibly, as a response responsive to the user query. For example, the generative NL content and/or other generative content (e.g., image) may be rendered visually via the graphical user interface of the chat application that accesses the generative model. Additionally, or alternatively, the generative NL content may be rendered audibly via the audible user interface of the chat application.

Once the response is rendered, the user is typically forced to provide an additional user query if seeking follow-up information with respect to the generative content that is present in the response. For example, each time the user seeks additional information, the user will have to provide a properly formulated user query for the generative model to provide responsive generative content. The multiple instances of prompts derived from different user queries using the generative model can consume intensive computational resources and result in prolonged interaction between the user and the chat application that accesses the generative model. Further, some generative models have been trained or fine-tuned to embed the response (or a portion thereof) with hyperlink(s) that lead to additional information with respect to the response. However, such hyperlink(s), when selected (e.g., clicked) by the user, can guide the user to leave the user interface of the chat application to access a webpage or other resource that is launched using a web browser. This requires manual switching between the chat application and the web browser, which can prolong a human to computer interaction, can be cumbersome (e.g., especially on smartphones or other devices with constrained displays), and/or require multiple manual operations that utilize various types of resources (e.g., computational, network, battery).

### SUMMARY

Techniques are described herein for fine-tuning and/or utilization of a generative model (e.g., a large language model, “LLM”) to not only generate a response responsive to an initial user query, but also to generate one or more follow-up prompts in association with the generated response. This provides an easy and one-click approach for a user to dive deeper into an existing human-to-computer conversation between the user and an application (e.g., a chat application) that accesses the generative model, without the user manually providing (e.g., typing or speaking) additional user queries. In various implementations, the one or more follow-up prompts are processable using the generative model. In various implementations, the response can be rendered visually in response to the initial user query via a graphical user interface (GUI) of the chat application (or a different application, e.g., an assistant application), and the one or more follow-up prompts can each be embedded in a corresponding portion of the rendered response.

As a non-limiting working example, a user may provide an initial user query to an assistant application, where the initial user query can be “Who was Bernoulli?”. The assistant application can access a fine-tuned LLM, and an initial prompt can be derived from the initial user query and be processed as input using the fine-tuned LLM. The initial prompt can include, for instance, the initial user query and a response-generation instruction for prompt-embedded response (sometimes referred to shortly as “complex instruction”). The response-generation instruction for prompt-embedded response, for instance, can include (i) a first instruction portion that instructs the fine-tuned LLM to generate a response for a user query (e.g., the initial user query, or a subsequent user query), (ii) a second instruction portion that instructs the fine-tuned LLM to identify, in the response, one or more portions for follow-up interaction, and/or (iii) a third instruction portion that instructs the fine-tuned LLM to determine and associate a respective follow-up prompt with each identified portion of the response. The respective follow-up prompt can be processed as input using the fine-tuned LLM.

In some implementations, instead of the follow-up prompt, the third instruction portion can cause the fine-tuned LLM to be utilized to determine and associate a respective follow-up query with each identified portion of the response. The follow-up query can be, for instance, a synthesized user query in natural language. In some implementations, the fine-tuned LLM can be further fine-tuned so that the follow-up query (without any instruction portion(s)) can be processed as input using the further fine-tuned LLM. In some other implementations, the follow-up query can be combined with the aforementioned complex instruction (or other applicable response-generation instruction) to generate the follow-up prompt, and the follow-up prompt can be processed as input using the fine-tuned LLM.

Optionally, the first instruction portion can further cause the fine-tuned LLM to format the response in a particular manner. For example, the first instruction portion can further cause utilization of the fine-tuned LLM to generate the response in a markup language such as HTML/json/xml, to generate the response to have a threshold number of sentences, and/or to generate the response in natural language with or without emojis. The threshold number of sentences can be, for instance, 3 sentences, 4 sentences, or any other appropriate number of sentences. Optionally, the second instruction portion can further cause the fine-tuned LLM to identify a predefined number of portions (or sections) in the response. The predefined number of portions can be, for instance, 2 portions, 3 portions, or any other applicable number. Alternatively, or additionally, the second instruction portion can further cause utilization of the fine-tuned LLM to highlight (e.g., underline, in a selected color, bold, etc.) each identified portion of the response and/or to associate a follow-up prompt with a corresponding identified portion using a tag (e.g., an anchor tag with a href attribute, an <a> tag). Optionally, the third instruction portion can cause utilization of the fine-tuned LLM to determine and associate a respective follow-up query (instead of the aforementioned follow-up prompt) with each identified portion of the response. Optionally, the response-generation instruction for prompt-embedded response (the “complex instruction”) can further include a fourth instruction portion that instructs the fine-tuned LLM to include one or more emojis in the response. But this is not required. Descriptions of examples of the complex instruction will be provided in more detail later in this disclosure, and are not limited herein.

Continuing with the non-limiting example above, the response-generation instruction for prompt-embedded response can be, for instance, “Answer the question “{insert user query here}” in no more than 3 sentences. Please format your answer in HTML code. Use <a href=“?query={QUERYTEXT}”>tags to highlight 3 sections that are most likely to be follow-up links. For each <a href=“?query={QUERYTEXT}>” tag, replace {QUERYTEXT} with a follow-up question phrased as an inquisitive prompt. Also include matching emojis in the answer where they make sense. Only include the reformatted answer in your response. Do not wrap your answer in quotes.”

Continuing with the non-limiting example above, the initial prompt to be processed using the fine-tuned LLM responsive to the user query can be, for instance, “Answer the question “{Who was Bernoulli?}” in no more than 3 sentences. Please format your answer in HTML code. Use <a href=“?query={QUERYTEXT}”>tags to highlight 3 sections that are most likely to be follow-up links. For each <a href=“?query={QUERYTEXT}>” tag, replace {QUERYTEXT} with a follow-up question phrased as an inquisitive prompt. Also include matching emojis in the answer where they make sense. Only include the reformatted answer in your response. Do not wrap your answer in quotes.”

Continuing with the non-limiting example above, based on processing the initial prompt as described above, the fine-tuned LLM can generate a model output from which a response to the initial prompt can be derived. The response to the initial prompt for the user query of “Who was Bernoulli?”, formatted in HTML code, can be “<p> The <a href=”?query=Who are members of the Bernoulli family? “>Bernoulli</a>name refers to several prominent Swiss mathematicians of the 17th and 18th centuries, such as Jakob, Johann, and Daniel Bernoulli. They are known for their significant contributions to <a href=”?query=What contributions did Bernoulli make to calculus? “>calculus </a> and <a href=”? query=What is Bernoulli's principle? “>Bernoulli's principle</a> in fluid dynamics. [symbol] </p>”

In the above working example of the response which is formatted in HTML code and which is responsive to the user query of “Who was Bernoulli?”, three portions of the response are identified, including a first portion that corresponds to “Bernoulli” which is highlighted using a first anchor tag of “<a href=“?query=Who are members of the Bernoulli family?”>”. The three identified portions of the response responsive to the user query of “Who was Bernoulli?” can further include a second portion that corresponds to “calculus” which is highlighted using a second anchor tag of “<a href=”?query=What contributions did Bernoulli make to calculus? “>”. The three identified portions of the response responsive to the user query of “Who was Bernoulli?” can further include a third portion that corresponds to “Bernoulli's principle” which is highlighted using a third anchor tag of “<a href=”? query=What is Bernoulli's principle? “>”. It is noted that the generated response can include an emoji based on the term “fluid” in the response, such as a water wave emoji (“ [symbol] ”) indicating fluid.

Such response is reformatted based on the HTML code before being visually rendered, and when visually rendered in response to the user query, can be as follows: “The Bernoulli name refers to several prominent Swiss mathematicians of the 17^{th} and 18^{th} centuries, such as Jakob, Johann, and Daniel Bernoulli. They are known for their significant contributions to calculus and Bernoulli's principle in fluid dynamics. [symbol] ” It is noted that the water wave emoji (“ [symbol] ”) indicating fluid in the rendered response (e.g., which is rendered visually to the user via a GUI of the assistant application) can be different from the water wave emoji (“ [symbol] ”) indicating fluid formatted in the HTML code.

Continuing with the non-limiting example above, the visually rendered response can include three highlighted portions, where a first highlighted portion of the response can highlight the phrase “Bernoulli” in the first sentence of the response, a second highlighted portion of the response can highlight the phrase “calculus” in the response, and a third highlighted portion of the response can highlight the phrase “Bernoulli's principle” in the response. Each of the first highlighted portion, the second highlighted portion, and the third highlighted portion of the response can be embedded with a respective link. For example, the first highlighted portion can be embedded with a first link, that when the first highlighted portion is selected by the user, causes the first link to be executed, which results in a first follow-up query (or a first follow-up prompt) to be processed using the fine-tuned LLM. The second highlighted portion can be embedded with a second link, that when the second highlighted portion is selected by the user, causes the second link to be executed, which results in a second follow-up query (or a second follow-up prompt) to be processed using the fine-tuned LLM. The third highlighted portion can be embedded with a third link, that when the third highlighted portion is selected by the user, causes the third link to be executed, which results in a third follow-up query (or a third follow-up prompt) to be processed using the fine-tuned LLM.

For instance, the first highlighted portion (e.g., “Bernoulli”) can be selectable, and when selected, can cause a first follow-up query of “Who are members of the Bernoulli family?” to be provided to the fine-tuned LLM. The first follow-up query (or a first follow-up prompt automatically generated to include the first follow-up query and the complex instruction as described above), can be processed using the fine-tuned LLM to generate a first follow-up response responsive to the first follow-up query. Give the first follow-up query being “Who are members of the Bernoulli family?”, the first follow-up response can be, for instance, “There are eight members of the Bernoulli family who contributed substantially to the development of mathematics and physics during the early modern period. They are Jacob Bernoulli, Johann Bernoulli, Nicolaus I Bernoulli, Nicolaus II Bernoulli, Daniel Bernoulli, Johann II Bernoulli, Johann III Bernoulli, Jacob II Bernoulli.” Optionally, the first follow-up query can have three highlighted portions each being selectable and embedded with a respective follow-up query (or prompt) determined for a respective highlighted portion.

In some implementations, the second highlighted portion (e.g., “calculus”) can be selectable, and when selected, can cause a second follow-up query of “What contributions did Bernoulli make to calculus?” to be provided to the fine-tuned LLM. In this case, in response to a user selecting the second highlighted portion, the second follow-up query (or a second follow-up prompt automatically generated to include the second follow-up query and the complex instruction as described above), can be processed using the fine-tuned LLM to generate a second follow-up response responsive to the second follow-up query. Give the second follow-up query being “What contributions did Bernoulli make to calculus?”, the second follow-up response can be, for instance, “The Bernoulli family made significant contributions to the field of calculus. Jacob Bernoulli, for instance, discovered the Bernoulli numbers, a sequence of rational numbers that are deeply rooted in number theory . . . ” Optionally, the second follow-up query can have three highlighted portions each being selectable and being embedded with a respective follow-up query (or prompt) determined for a respective highlighted portion.

In some implementations, the third highlighted portion (e.g., “Bernoulli”) can be selectable, and when selected, can cause a third follow-up query of “What is Bernoulli's principle?” to be provided to the fine-tuned LLM. In this case, in response to a user selecting the third highlighted portion, the third follow-up query (or a third follow-up prompt automatically generated to include the third follow-up query and the complex instruction as described above), can be processed using the fine-tuned LLM to generate a third follow-up response responsive to the third follow-up query. Give the third follow-up query being “What is Bernoulli's principle?”, the third follow-up response can be, for instance, “Bernoulli's principle is a key concept in fluid dynamics that relates pressure, speed and height . . . ” Optionally, the third follow-up query can have three highlighted portions each being selectable and being embedded with a respective follow-up query (or prompt) determined for a respective highlighted portion.

In various implementations, a computer-implemented method (“a method”) and a system to implement the computer-implemented method are provided. The method can include: receiving, via an input device, a user input; in response to receiving the user input, generating a prompt that includes an instruction to generate a response to the user input, the instruction further requiring one or more follow-up queries (or follow-up prompts) to be generated for one or more portions of the generated response; processing the prompt as input, using a generative model, to generate a model output from which the response is derived, and causing the response to be rendered via a graphical user interface (GUI) of an output device. In some implementations, when rendered via the output device, the one or more portions of the response are each selectable and when selected, causes a corresponding follow-up prompt to be processed using the generative model, to generate a corresponding follow-up response. The corresponding follow-up response can be rendered in response to the user selecting a corresponding one of the one or more portions of the response.

In some implementations, the one or more portions of the response include a first portion that corresponds to a first entity identified from the user input.

In some implementations, the one or more portions of the response include a second portion that corresponds to a second entity identified in the generated response but not present in the user input.

In some implementations, when rendered via the output device, the one or more portions of the response are each embedded with a link identifying the corresponding follow-up query or follow-up prompt. In some implementations, when a particular portion from the one or more portions of the response is selected, a particular link embedded in the particular portion is executed to cause a corresponding particular follow-up prompt to be processed using the generative model.

In some implementations, the method further includes: receiving a user selection of a specific portion from the one or more portions of the response; and in response to receiving the user selection of the specific portion: processing the follow-up query or prompt for the specific portion, using the generative model, to generate a follow-up model output from which a follow-up response is derived, and causing the follow-up response to be rendered, via the GUI, responsive to the user selection of the specific portion.

The preceding is presented as an overview of only some implementations disclosed herein. These and other implementations are disclosed in additional detail herein. For example, additional and/or alternative implementations are disclosed herein such as limiting the total number of times in generating responses embedded with links that leads to follow-up queries or prompts.

By using techniques described herein, a response can be generated for a user query, providing rich context for the user query. For example, the generated response can include a highlighted portion which is embedded with a follow-up query determined based on content (e.g., a keyword) of the highlighted portion. The generated response can be reformatted and be rendered to a user, and in response to receiving user input from the user that selects the highlighted portion, the follow-up query (or a follow-up prompt processable using the fine-tuned LLM) can be processed using the fine-tuned LLM, to generate a follow-up response for the follow-up query.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B illustrates an example process flow of generating a response responsive to a user query, using a fine-tuned LLM in accordance with various aspects of the present disclosure.

FIG. 2A depicts an example of a response generated based on a user query, using a fine-tuned LLM in accordance with various aspects of the present disclosure.

FIG. 2B depicts an example of an additional response generated based on user selection of a follow-up query that is embedded in the response in FIG. 2A, using a fine-tuned LLM in accordance with various aspects of the present disclosure.

FIG. 2C depicts an example of a further response generated based on user selection of a further follow-up query that is embedded in the additional response in FIG. 2B, using a fine-tuned LLM in accordance with various aspects of the present disclosure.

FIG. 3A depicts an example of a complex instruction to formulate an LLM prompt (shortly as “prompt”) in accordance with various aspects of the present disclosure.

FIG. 3B depicts another example of a complex instruction to formulate an LLM prompt in accordance with various aspects of the present disclosure.

FIG. 4 depicts a flowchart illustrating an example method of generating a response, in accordance with various aspects of the present disclosure.

FIG. 5 depicts an example architecture of a computing device, in accordance with various implementations.

FIG. 6 depicts a flowchart illustrating an example method of fine-tuning a large language model using a training instance, in accordance with various aspects of the present disclosure.

FIG. 7 depicts a flowchart illustrating a response generated using an on device or remote LLM in accordance with various aspects of the present disclosure.

### DETAILED DESCRIPTION

As described previously, generative models such as large language models (“LLMs”) have been developed and be used to process user input (e.g., typed or audible, etc.) received from a user during a human-to-computer dialog, to generate output from which generative content responsive to the user input is derived. Once the response is rendered, the user is typically forced to provide an additional user query if the user wants to seek follow-up information with respect to the generated generative content. In fact, using conventional technologies, each time the user wants to seek additional information during a human-to-computer dialog, the user will have to provide a properly formulated user query for deriving a prompt and/or processing as input using the LLM, in order to generate content having the additional information that the user seeks. This results in prolonged interactions between the user and a chat application (or a different application) that accesses the LLM. It is noted that some LLMs have been trained or fine-tuned to embed the response (or a portion thereof) with hyperlink(s) that lead to additional information that supplements the response. However, such hyperlink(s), when selected (e.g., clicked) by the user, usually guide the user to leave the user interface of the chat application, for accessing a webpage that is launched using a web browser. This requires manual switching between the chat application and the web browser, and therefore causes inconvenience and involves multiple intensive manual operations that cost time and various types of resources (e.g., computational, network, battery).

To reduce or facilitate the user turns during the human-to-computer dialog, various implementations disclosed herein relate to utilizing prompt-engineering and/or a particularly fine-tune LLM in generating a response (e.g., in a mark-up language such as HTML code) for an initially received user query, where the response can include a plurality of identified portions each embedded with a link to a respective follow-up query (or a respective follow-up prompt). In various implementations, a user can select a particular portion of the response that is highlighted to learn additional information/knowledge associated with one or more keywords present in the particular portion. For example, in response to the user selecting the particular portion (out of the plurality of identified portions) from the response, a particular follow-up query (or a particular follow-up prompt) that is automatically synthesized using the fine-tuned LLM for the identified particular portion, can be processed as input, using the fined-tuned LLM, to generate a follow-up response responsive to the particular user query. This facilitates the human-to-computer interactions between the user and the application (that accesses the fine-tuned LLM), by reducing the time period a system (that implements the fine-tuned LLM) waits to receive additional user queries and therefore a total amount of interaction time. The reduced total amount of human-to-computer iteration time often means reduction in the various types of resources, such as battery resources and computational resources associated with receiving and recognizing manual input (or other operations) of the user.

The following description with reference to the accompanying drawings is provided for understanding of various implementations of the present disclosure. It should be appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

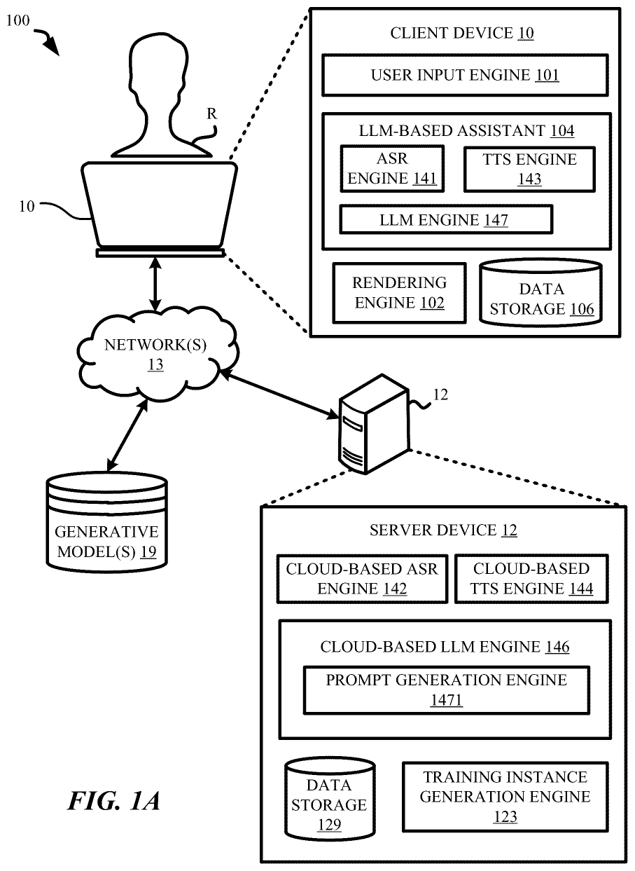

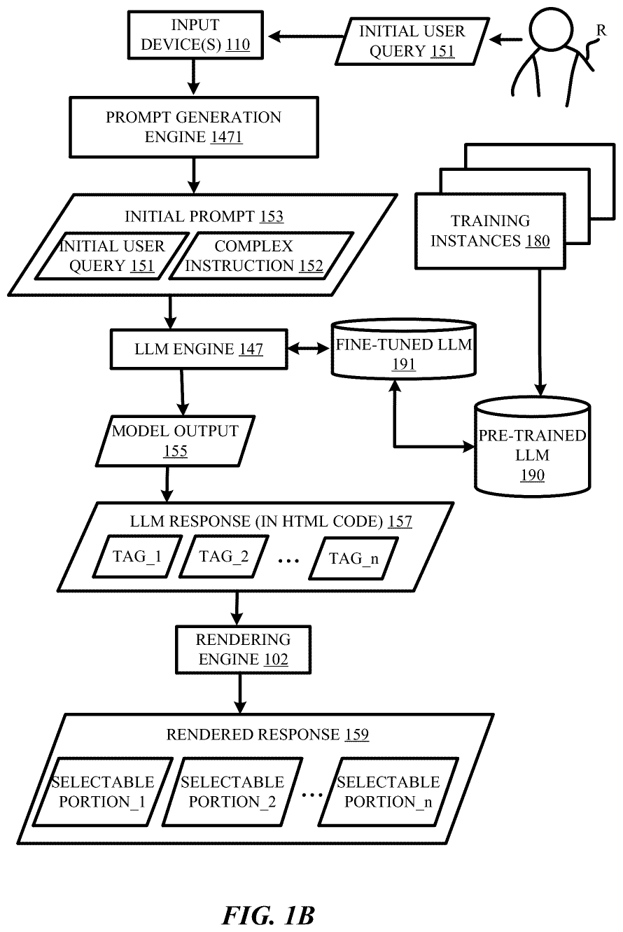

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) that is in communication with the client computing device 10. In some implementations, the server computing device 12 can be in communication with the client computing device 10 via one or more networks 13. The one or more networks 13 can include, for example, a local area network (LAN), a wide area network (WAN) such as the Internet, and/or any other appropriate network.

In some implementations, the client computing device 10 and/or the server computing device 12 can be in communication with one or more machine learning (ML) models 19, via the one or more networks 13. The one or more ML models 19 can include, for instance, a generative model and/or other models such as a convolutional neural network (CNN), recurrent neural network (RNN), etc. In various implementations, the generative model can be a large language model (“LLM”, see, e.g., 191 in FIG. 1B) having less than 100 billion parameters, more than 100 billion parameters, or over 200 billion parameters, etc. The greater the number of parameters of the LLM, the more complex (or sophisticated) a task (e.g., specified in a user query or request) the LLM can handle.

The LLM may be stored at the client computing device 10, or at the server computing device 12. For instance, if memory of the client computing device 10 restricts the storing of the LLM at the client computing device 10 or if a token length of a user input (or prompt) to be processed using the LLM exceeds a predetermined token length, the LLM may be stored at the server computing device 12. For instance, if the memory of the client computing device 10 does not restrict the storing of the LLM at the client computing device 10, the LLM may be stored at the client computing device 10, to reduce a latency in completing a task (e.g., specified in the user query or request), for instance, by avoiding data communications via the one or more networks 13.

In some implementations, the LLM can be transformer-based and be acquired based on fine-tuning a pre-trained LLM (e.g., 190 in FIG. 1B) using one or more training instances (e.g., 180 in FIG. 1B) curated in accordance with the present disclosure. The pre-trained LLM can be acquired based on pre-training an initial LLM using data from a diversity of sources such as webpages, published articles, etc. One non-limiting example of the pre-trained LLM is GOOGLE'S Pathways Language Model (PaLM). Another non-limiting example of the pre-trained LLM is GOOGLE'S Language Model for Dialogue Applications (LaMDA).

In some implementations, the client computing device 10 can be, for example, a desktop computing device, a laptop computing device, a tablet computing device, a mobile phone computing device, a computing device of a vehicle (e.g., an in-vehicle entertainment system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

In some implementations, the client computing device 10 can include one or more applications installed locally at, or otherwise accessible via, the client computing device 10. The one or more applications of the client computing device 10 can include, for instance, an LLM-based assistant 104 (or other chat application) that includes, or otherwise accesses the generative model (e.g., LLM 191) for performing human-to-user interactions (e.g., to carry out human-to-computer dialogs). In some implementations, the LLM-based assistant 104 includes, or otherwise accesses, a user input engine 101 and/or a rendering engine 102. In some implementations, the client computing device 10 can include a data storage 106. The data storage 106 of the client computing device 10, for instance, can store metadata (e.g., a user profile of a user, etc.) associated with the one or more applications (e.g., 104) and/or associated with the client computing device 10.

The user input engine 101 can be configured to detect user input provided by a user of the client computing device 10. The user input may be provided by the user using one or more user interface input devices (e.g., 110 in FIG. 1B), such as a keyboard, a touch screen, a microphone, etc. The user input can be typed input, touch input, audible input, or any other applicable type of input. For example, the client computing device 10 can be equipped with a keyboard to receive typed input, and/or a mouse (or one or more hardware buttons) to receive a user click that selects one or more graphical user interface (GUI) elements that is rendered visually at a user interface of the client computing device 10. Additionally, or alternatively, the client computing device 10 can be equipped with one or more microphones that capture audio data, such as audio data capturing spoken utterances of the user and/or other sounds in an environment of the client computing device 10. Additionally, or alternatively, the client computing device 10 can be equipped with one or more vision components that are configured to capture vision data corresponding to images and/or movements (e.g., gestures) detected within a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input that is directed to the client computing device 10.

In various implementations, the rendering engine 102 can be configured to provide content for audible and/or visual presentation to a user of the client computing device 10 using one or more user interface output devices (e.g., display, speaker, etc.). For example, the client computing device 10 can be equipped with one or more speakers that enable content (e.g., “The method of integration by parts in calculus is a technique used for solving integrals that allows you to transform the integral of a product of two functions into simpler parts.”) to be provided for audible presentation to a user of the client computing device 10. Additionally, or alternatively, the client computing device 10 can be equipped with a display or projector that enables content (e.g., “Based on the formula ∫udv=uv−∫vdu”, it's used when the integral is a product of ‘u’—the function to be differentiated and ‘dv’—the function to be integrated.) to be provided for visual presentation to the user via the client computing device 10.

In various implementations, the LLM-based assistant 104 can include local components such as an automatic speech recognition (ASR) engine 141 and/or a text-to-speech (TTS) engine 143. Additionally, or alternatively, the plurality of local components of the LLM-based assistant 104 can include other component(s) such as an LLM engine 147. It is noted that, in some implementations, the user input engine 101, the rendering engine 102, the ASR engine 141, the TTS engine 143, and/or the LLM engine 147 do not necessarily need to be all included in the LLM-based assistant 104. For instance, the user input engine 101 and/or the rendering engine 102 can be included in the client computing device 10 and be shared across one or more of the applications that are installed at (or accessible via) the client computing device 10. As another example, the ASR engine 141, the TTS engine 143, and/or the LLM engine 147 can each additionally (or alternatively) have a corresponding cloud-based counterpart (e.g., 142, 144, 146, etc.) that is located at, or accessible via, a server (e.g., the server computing device 12 or other server(s)).

In some implementations, a user (e.g., user R) of the client computing device 10 may have a registered account associated with the LLM-based assistant 104 and/or other application(s). The other applications can include, for example, a social media application, a video player, a note-taking application, a shopping application, a messaging application, and/or any other appropriate applications (or services), installed at, or accessible via, the client computing device 10.

In various implementations, the ASR engine 141 (or 142) can process, using one or more streaming ASR models (e.g., a recurrent neural network (RNN) model, a transformer model, and/or any other type of ML model capable of performing ASR), streams of audio data that capture spoken utterances (also referred to as “voice input”, “user speech”, etc.), to generate corresponding streams of ASR output. The ML model(s) can be on-device ML models that are stored locally at the client computing device 10, remote ML models that are executed remotely from the server computing device (e.g., at remote server device 12), or shared ML models that are accessible to the client computing device 10 and/or remote systems (e.g., the remote server computing device 12). The audio data can be acquired from audio recordings or can be generated by microphone(s) of the client computing device 10. Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 141 can select one or more of the ASR hypotheses as corresponding recognized text (“transcript”, “transcription”) that corresponds to the spoken utterance(s) (e.g., selected based on the corresponding predicted measures).

In various implementations, the TTS engine 143 (or 144) can process, using TTS model(s), corresponding streams of textual content (e.g., content generated based at least on processing the recognized text using the LLM, or a predetermined text, etc.), to generate synthesized speech audio data that includes computer-generated synthesized speech. The synthesized speech audio data can be rendered audibly via one or more user interface output devices, such as a speaker. In additional or alternative implementations, the synthesized speech audio data can be pre-cached in memory or in one or more databases accessible by the client computing device 10.

In various implementations, the LLM engine 147 (or the cloud-based LLM engine 146) can access the aforementioned generative model (e.g., LLM 191). In various implementations, the LLM engine 147 can include, or otherwise access, a prompt generation engine 1471 that generates prompt(s) based on user input(s). The generated prompt(s) can be processed by the LLM engine 147, using the generative model, to generate model output(s) from which response(s) to the user input(s) can be derived.

In various implementations, the server computing device 12 can be, for example, a web server, one or more blade servers acting together to provide “cloud” infrastructure, or any other type of server as needed. In various implementations, as described above, the server computing device 12 can optionally include a cloud-based ASR engine 142, a cloud-based TTS engine 144, and/or a cloud-based LLM engine 146. In various implementations, the server computing device 12 can include a training instance generation engine 123, and/or a data storage 126.

In some implementations, the training instance generation engine 123 can be used to generate one or more training instances (e.g., 180 in FIG. 1B) for fine-tuning the pre-trained LLM as described above. The generated one or more training instances can be stored, for example, at the data storage 126 and/or other databases or storages.

FIG. 1B illustrates an example process flow of generating a response using a fine-tuned LLM in accordance with various aspects of the present disclosure. As shown in FIG. 1B, during a human-to-computer dialog, a user (e.g., user R) can provide an initial user query 151 to user interface input device(s) 110 of a client computing device such as a laptop, a smart phone, etc. The initial user query 151 can be captured in a spoken utterance, typed input, or other type of user input, from the user. As described previously, the user interface input device(s) 110 can be, or can include, one or more microphones, a touch screen, a keyboard, etc.

In some implementations, the initial user query 151 may be captured in a spoken utterance, and audio data capturing the spoken utterance can be detected using microphone(s) as the input device(s) 110. In this case, the audio data capturing the spoken utterance can be processed using the aforementioned ASR engine (e.g., 141), to determine a speech recognition of the spoken utterance, from which the initial user query 151 can be determined. In some other implementations, the initial user query 151 may be captured in a typed input, and the typed input can be detected using a keyboard as the input device(s) 110. In this case, the typed input can be processed to determine the initial user query 151. The initial user query 151 may also be captured in and/or determined from other types of user input, and the present disclosure is not limited thereto.

In some implementations, the initial user query 151 can be forwarded to the prompt generation engine 1471, where the prompt generation engine 1471 can process the initial user query 151 to generate an initial prompt 153. In some implementations, the prompt generation engine 1471 can generate the initial prompt 153 to include the initial user query 151 and a complex instruction 152 (e.g., a response-generation instruction for prompt-embedded response). The complex instruction 152, for instance, can include (i) a first instruction portion that instructs the fine-tuned LLM to generate a response for a user query (e.g., the initial user query, or a subsequent user query), (ii) a second instruction portion that instructs the fine-tuned LLM to identify, in the response, one or more portions for follow-up interaction, and/or (iii) a third instruction portion that instructs the fine-tuned LLM to determine and associate a respective follow-up prompt with each identified portion of the response. The respective follow-up prompt can be processed as input using the fine-tuned LLM. It is noted that, optionally, the fine-tuned LLM needs not be identified or mentioned in the complex instruction 152.

In some implementations, instead of the follow-up prompt, the third instruction portion can cause utilization of the fine-tuned LLM to determine and associate a respective follow-up query with each identified portion of the response. The follow-up query can be, for instance, a synthesized user query in natural language. In some implementations, the fine-tuned LLM can be further fine-tuned so that the follow-up query (without any instruction portion(s)) can be processed as input using the further fine-tuned LLM. In some other implementations, the follow-up query can be combined with the aforementioned complex instruction (or other applicable response-generation instruction) to generate the follow-up prompt, and the follow-up prompt can be processed as input using the fine-tuned LLM.

Optionally, the first instruction portion can further instruct the fine-tuned LLM to format the response in a particular manner (e.g., generating the response in HTML code, generating the response within a threshold number of sentences, and/or rendering the response based on the HTML code). The threshold number of sentences can be, for instance, 3 sentences, 4 sentences, or any other appropriate number of sentences. Optionally, the second instruction portion can further instruct the fine-tuned LLM to identify a predefined number of portions (or sections) in the response. The predefined number of portions can be, for instance, 2 portions, 3 portions, or any other applicable number. Alternatively, or additionally, the second instruction portion can further instruct the fine-tuned LLM to highlight (e.g., underline, in a selected color, bold, etc.) each identified portion of the response and/or to associate a follow-up prompt with a corresponding identified portion using a tag (e.g., a <href> tag). Optionally, the third instruction portion can instruct the fine-tuned LLM to determine and associate a respective follow-up query (instead of the aforementioned follow-up prompt) with each identified portion of the response. Optionally, the response-generation instruction for prompt-embedded response (the “complex instruction”) can further include a fourth instruction portion that instructs the fine-tuned LLM to include one or more emojis in the response.

In some implementations, the initial prompt 153 can be processed by the LLM engine 147, using the fine-tuned LLM 191, to generate a model output 155 from which a LLM response 157 (e.g., in a markup language such as HTML code, json, xml) can be derived. In some implementations, the LLM response 157 can be in HTML code and/or include one or more tags (TAG_1, TAG_2, . . . , TAG_n) for identifying one or more portions of the LLM response 157. The one or more portions of the LLM response 157 can be identified, for instance, based on each portion of the LLM response 157 having a score that indicates a likelihood of user selection satisfying a numeric threshold (e.g., 0.7). A non-limiting example of TAG_1, TAG_2, . . . , or TAG_n, can be an anchor tag (“<a>tag”) with a href attribute that defines a follow-up query based on content from a corresponding portion of the LLM response 157.

In some implementations, the LLM response 157 can be rendered, using the rendering engine 102. The rendered response 159 can be different from the LLM response 157 in the HTML code. For example, the rendered response 159 can be a re-formatted version (e.g., not showing any computer code or tag) of the LLM response 157 (which is in the HTML code or other markup language).

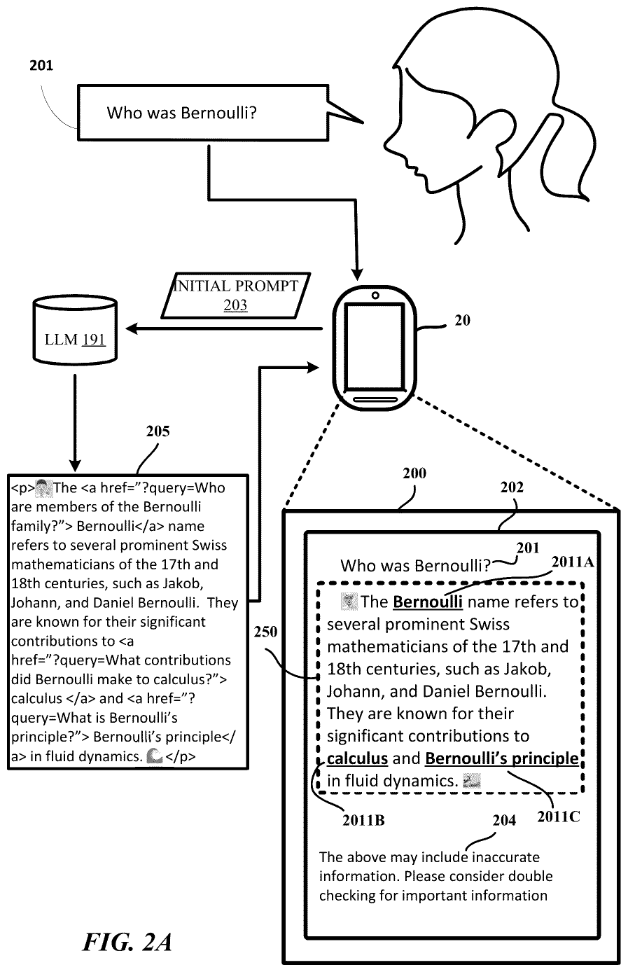

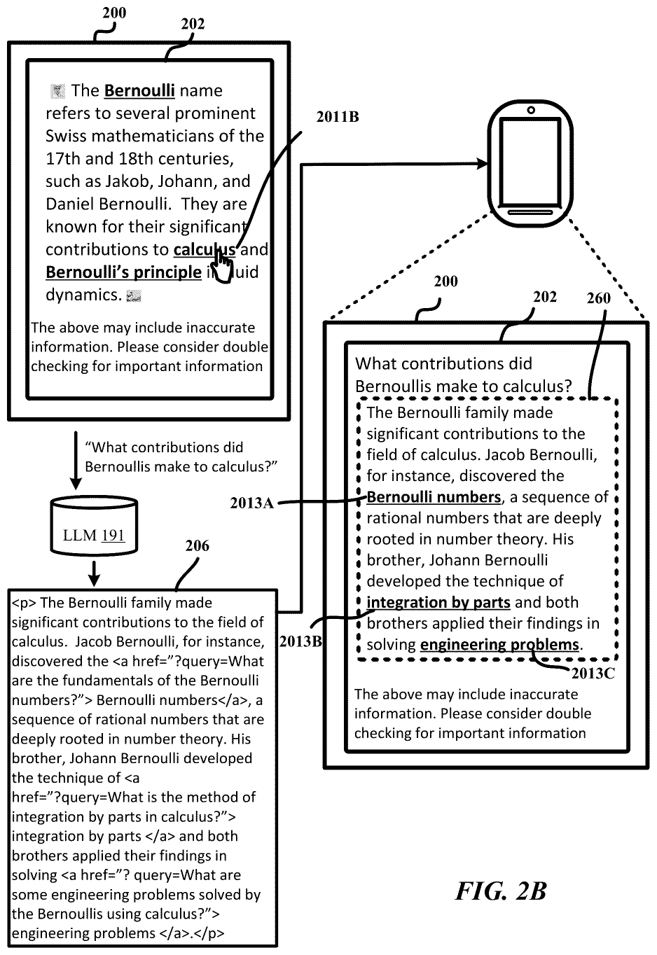

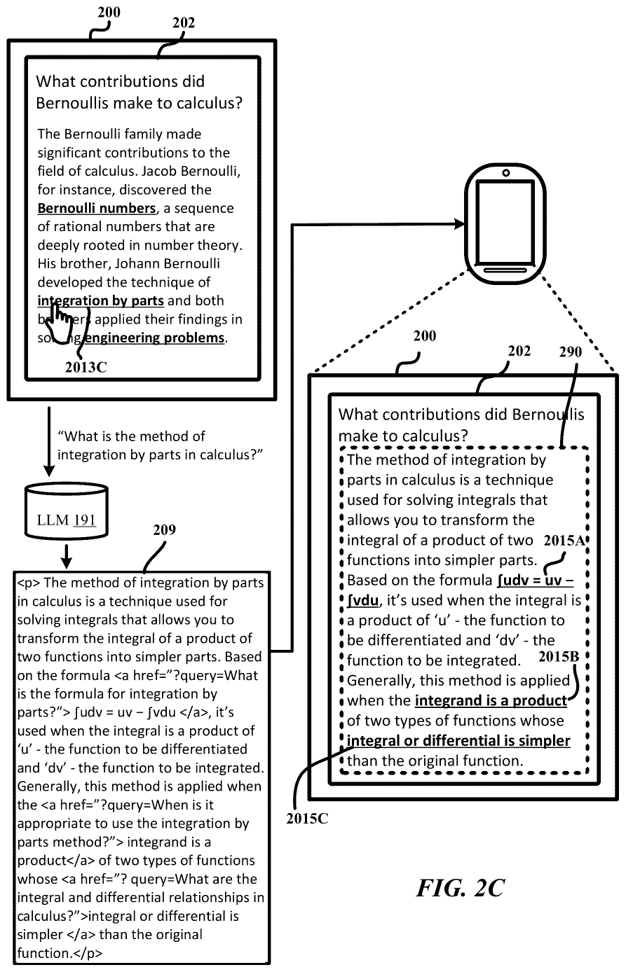

FIG. 2A depicts an example of a response generated based on a user query, using a fine-tuned LLM in accordance with various aspects of the present disclosure. FIG. 2B depicts an example of an additional response generated based on user selection of a follow-up query that is embedded in the response in FIG. 2A, using a fine-tuned LLM in accordance with various aspects of the present disclosure. FIG. 2C depicts an example of a further response generated based on user selection of a further follow-up query that is embedded in the additional response in FIG. 2B, using a fine-tuned LLM in accordance with various aspects of the present disclosure.

As a non-limiting example, referring to FIG. 2A, a user may provide a user utterance 201 (also referred to as “spoken utterance”, “user speech”, “voice input”, etc.), such as “Who was Bernoulli?” to a chat application (e.g., LLM-based assistant 104) that is accessible via a client device 20, during a dialog session between the user and the chat application. Audio data capturing the user utterance 201 of “Who was Bernoulli?” may be detected by one or more microphones of the client device 20. The captured audio data may be processed using an ASR engine (e.g., 141 and/or 142), to determine a speech recognition (also referred to as “transcript” or “transcription”) of the user utterance 201. The speech recognition of the user utterance 201 (e.g., “Who was Bernoulli?” in natural language) can be processed, e.g., using the prompt generation engine 1471) to determine an initial prompt 203 for processing as input using a fine-tuned LLM 191. The initial prompt 203 can include the speech recognition of the user utterance 201 and a complex instruction as described above. Optionally, the fine-tuned LLM 191 can be fine-tuned in a way that the complex instruction can be omitted from the initial prompt 203.

In some implementations, the complex instruction can include: (i) a first instruction portion that instructs the fine-tuned LLM to generate a response for a user query (e.g., the initial user query, or a subsequent user query), (ii) a second instruction portion that instructs the fine-tuned LLM to identify, in the response, one or more portions for follow-up interaction, and/or (iii) a third instruction portion that instructs the fine-tuned LLM to determine and associate a respective follow-up prompt with each identified portion of the response.

In some implementations, instead of the follow-up prompt, the third instruction portion can instruct the fine-tuned LLM to determine and associate a respective follow-up query with each identified portion of the response. The follow-up query can be, for instance, a synthesized user query in natural language. In some implementations, the fine-tuned LLM can be further fine-tuned so that the follow-up query (without any instruction portion(s)) can be processed as input using the further fine-tuned LLM. In some other implementations, the follow-up query can be combined with the aforementioned complex instruction (or other applicable response-generation instruction) to generate the follow-up prompt, and the follow-up prompt can be processed as input using the fine-tuned LLM.

Optionally, the first instruction portion can further instruct the fine-tuned LLM to format the response in a particular manner (e.g., generating the response in a markup language such as HTML/json/xml, generating the response to have a threshold number of sentences, and/or rendering the response in natural language with or without emojis). The threshold number of sentences can be, for instance, 3 sentences, 4 sentences, or any other appropriate number of sentences. Optionally, the second instruction portion can further instruct the fine-tuned LLM to identify a predefined number of portions (or sections) in the response. The predefined number of portions can be, for instance, 2 portions, 3 portions, or any other applicable number. Alternatively, or additionally, the second instruction portion can further instruct the fine-tuned LLM to highlight (e.g., underline, in a selected color, bold, etc.) each identified portion of the response and/or to associate a follow-up prompt with a corresponding identified portion using a tag (e.g., an anchor tag with a href attribute, an <a> tag). Optionally, the third instruction portion can instruct the fine-tuned LLM to determine and associate a respective follow-up query (instead of the aforementioned follow-up prompt) with each identified portion of the response. Optionally, the response-generation instruction for prompt-embedded response (the “complex instruction”) can further include a fourth instruction portion that instructs the fine-tuned LLM to include one or more emojis in the response. But this is not required. Descriptions of the complex instruction will be provided in more detail later in this disclosure, and are not limited herein.

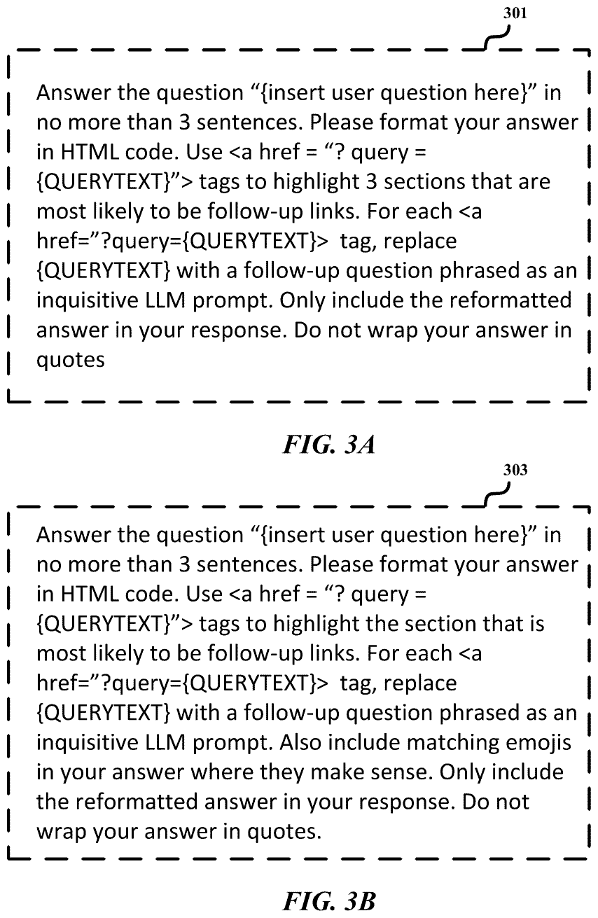

As a working example, referring to FIG. 3A, the complex instruction 152 can include, for instance, content 301 of “Answer the question “{insert user question here}” in no more than 3 sentences. Please format your answer in HTML code. Use <a href=“? query={QUERYTEXT}”>tags to highlight 3 sections that are most likely to be follow-up links. For each <a href=“?query={QUERYTEXT}>tag, replace {QUERYTEXT} with a follow-up question phrased as an inquisitive LLM prompt. Only include the reformatted answer in your response. Do not wrap your answer in quotes”. As another working example, referring to FIG. 3B, the complex instruction 152 can include, for instance, content 303 of “Answer the question “{insert user question here}” in no more than 3 sentences. Please format your answer in HTML code. Use <a href=“? query={QUERYTEXT}”>tags to highlight the section that is most likely to be follow-up links. For each <a href=“?query={QUERYTEXT}>tag, replace {QUERYTEXT} with a follow-up question phrased as an inquisitive LLM prompt. Also include matching emojis in your answer where they make sense. Only include the reformatted answer in your response. Do not wrap your answer in quotes”.

The initial prompt 203 can be provided to a generative model (e.g., the fine-tuned LLM) that is in communication with the chat application. Such a generative model can be a fine-tuned LLM (e.g., LLM 191) acquired based on fine-tuning a pre-trained LLM using one or more training instances (e.g., 180 in FIG. 1B). Processing of the initial prompt 203 that is derived from the user utterance 201 (or other types of user input, such as a typed input), using the fine-tuned LLM 191, can result in a model output from reflecting a response 205 (may also be referred to as a “LLM response”) in a markup language (e.g., HTML/XML/JSON).

As shown in FIG. 2A, the response 205 derived from the model output of the LLM 191 that corresponds to the user utterance 201 of “Who was Bernoulli” can be in HTML code (or other markup language such as JSON). The response 205 in HTML code can be, for instance, “<p> The <a href=”?query=Who are members of the Bernoulli family? “>Bernoulli</a>name refers to several prominent Swiss mathematicians of the 17^{th} and 18^{th} centuries, such as Jakob, Johann, and Daniel Bernoulli. They are known for their significant contributions to <a href=”?query=What contributions did Bernoulli make to calculus? “>calculus </a> and <a href=”? query=What is Bernoulli's principle? “>Bernoulli's principle</a> in fluid dynamics. </p>”. Optionally, the response 205 can include one or more emojis for one or more words or phrases in the response 205. For instance, the response 205 can include a wave emoji for the phrase “fluid” in the response 205. It is noted that, however, such response 205 in the markup language (e.g., HTML code) may not be rendered visually or audibly to the user of the user utterance 201.

As can be seen from the response 205 in HTML code in FIG. 2A, the response 205 can include one or more follow-up queries (or prompts) each associated with a key phrase (e.g., “Bernoulli”, “calculus”, or “Bernoulli's principle”) in the response 205, where each follow-up query (or prompt) can be identified in the “href” attribute of an anchor tag (e.g., <a href= . . . >tag, shortly referred to as an “<a>tag”). For instance, the response 205 in HTML code can include a total number of three anchor tags. The three anchor tags can include a first anchor tag of <a href=“?query=Who are members of the Bernoulli family?”>, a second anchor tag of <a href=“?query=What contributions did Bernoulli make to calculus?”>, and a third anchor tag of <a href=“? query=What is Bernoulli's principle?”>.

These anchor tags (e.g., <a href=“?query=Who are members of the Bernoulli family?”>, etc.), and other tags in the response 205 such as a <p> tag which defines a paragraph, are not intended to be rendered visually or audibly to the user of the user utterance 201. In some implementations, the total number of anchor tags included in the response 205 (which in the format of markup language) is not limited to “3”, but can be any other applicable integrals. In some implementations, the total number of anchor tags included in the response 205 can be predefined in the complex instruction (e.g., “301” in FIG. 3A or “303” in FIG. 3B) that forms part of the initial prompt 203.

In some implementations, the response 205 in the markup language can be processed, using a rendering engine (e.g., 102 in FIG. 1A), so that a response 250 can be rendered visually and/or audibly to a user of the user utterance 201. As shown in FIG. 2A, the response 250 rendered in response to the user utterance 201 (e.g., “Who was Bernoulli?”) can, for instance, include word content of “The Bernoulli name refers to several prominent Swiss mathematicians of the 17^{th} and 18^{th} centuries, such as Jakob, Johann, and Daniel Bernoulli. They are known for their significant contributions to calculus and Bernoulli's principle in fluid dynamics.” In some implementations, the response 250 can include one or more emojis, for instance, if the complex instructions cause the LLM to output emojis when applicable. The one or more emojis, when displayed at different client devices having different manufacturers or operating systems, may have different visual appearances.

Further referring to FIG. 2A, the response 250 rendered via a user interface 202 of the chat application, which is within a user interface 200 of the client device 20, can include one or more portions (e.g., highlighted portions) each embedded with a link or tag (e.g., the anchor tag) that is selectable, and when selected, causes a corresponding follow-up query (or follow-up prompt) to be processed as input using the fine-tuned LLM 191. For instance, the response 205 (e.g., in the markup language) can include the first anchor tag of <a href=“?query=Who are members of the Bernoulli family?”> for a first key phrase of “Bernoulli”, a second anchor tag of <a href=“?query=What contributions did Bernoulli make to calculus?”> for a second key phrase of “calculus”, and a third anchor tag of <a href=“? query=What is Bernoulli's principle?”> for a third key phrase of “Bernoulli's principle”. In this case, the rendered response 250 can include a first highlighted portion 2011A highlighting (e.g., by coloring, bold, underlining, etc.) the first key phrase of “Bernoulli”, a second highlighted portion 2011B highlighting the second key phrase of “calculus”, and a third highlighted portion 2011C highlighting the third key phrase of “Bernoulli's principle”.

The first highlighted portion 2011A (e.g., the first key phrase) can be selectable and be embedded with a first hyperlink which, when the first key phrase is selected by a user (e.g., user R), causes a first follow-up query (“Who are members of the Bernoulli family?”) identified from the first anchor tag to be processed automatically (i.e., without additional user operation other than selecting the first highlighted portion 2011A) using the generative model (e.g., LLM 191). The second highlighted portion 2011B (e.g., the second key phrase) can be selectable and be embedded with a second hyperlink which, when the second key phrase is selected by a user (e.g., user R), causes a second follow-up query (“What contributions did Bernoulli make to calculus?”) that is identified from the second anchor tag to be processed automatically using the generative model (e.g., LLM 191). The third highlighted portion 2011C (e.g., the third key phrase) can be selectable and be embedded with a third hyperlink which, when the third key phrase is selected by a user (e.g., user R), causes a third follow-up query (“What is Bernoulli's principle?”) that is included in the third anchor tag to be processed automatically using the generative model (e.g., LLM 191).

In some implementations, the response 250 can be rendered visually via the client device 20. For instance, the response 250 can be rendered visually with respect to (e.g., below) the speech recognition of the user utterance 201, as being responsive to the user utterance 201. In some implementations, optionally, the user interface 202 can include or display disclaimer languages 204, such as “The above may include inaccurate information. Please consider double checking the validity if the above is considered important information.”

In various implementations, referring to FIG. 2B, a user may select (e.g., click) the second highlighted portion 2011B (e.g., the second key phrase of “calculus”) that is visually displayed via the user interface 200 of the client device 20. In response to receiving the user's selection of the second highlighted portion 2011B, the second follow-up query (e.g., “What contributions did Bernoulli make to calculus?”) can be provided to the prompt generation engine (e.g., 1471 in FIG. 1A) and the LLM 191, to generate a response (e.g., the additionally rendered response 260) for the second follow-up query.

In some implementations, optionally, the prompt generation engine 1471 can process the second follow-up query (e.g., “What contributions did Bernoulli make to calculus?”) to generate an additional prompt. The additional prompt can include the second follow-up query and/or the aforementioned complex instruction. For instance, the second follow-up query can be inserted in the aforementioned complex instruction, to generate the additional prompt. The additional prompt can be processed using the LLM 191, to generate a model output from which an additional response 206 (in markup language) responsive to the additional prompt can be derived.

As shown in FIG. 2B, the additional response 206 (in markup language) can be, for instance, “<p> The Bernoulli family made significant contributions to the field of calculus. Jacob Bernoulli, for instance, discovered the <a href=“?query=What are the fundamentals of the Bernoulli numbers?”>Bernoulli numbers</a>, a sequence of rational numbers that are deeply rooted in number theory. His brother, Johann Bernoulli developed the technique of <a href=“?query=What is the method of integration by parts in calculus?”>integration by parts </a> and both brothers applied their findings in solving <a href=“? query=What are some engineering problems solved by the Bernoullis using calculus?”>engineering problems </a>. </p>”. It is noted that, the additional response 206 in markup language is not intended to be rendered directly to a user of the user utterance 201, but is to be processed using the rendering engine (e.g., 102 in FIG. 1A). The additional response 206 in markup language, when processed using the rendering engine 102, can become, for instance, an additionally rendered response 260 having word content of “The Bernoulli family made significant contributions to the field of calculus. Jacob Bernoulli, for instance, discovered the Bernoulli numbers, a sequence of rational numbers that are deeply rooted in number theory. His brother, Johann Bernoulli developed the technique of integration by parts and both brothers applied their findings in solving engineering problems.”.

In some implementations, the additional response 206 in markup language can include a first additional anchor tag of <a href=“?query=What are the fundamentals of the Bernoulli numbers?”> for a first additional phrase of “Bernoulli numbers”, and/or a second additional anchor tag of <a href=“?query=What is the method of integration by parts in calculus?”> for a second additional phrase of “integration by parts”. Additionally, or alternatively, the additional response 260 can include a third additional anchor tag of <a href=“? query=What are some engineering problems solved by the Bernoullis using calculus?”>for a third additional phrase of “engineering problem”.

Correspondingly, the additionally rendered response 260 (which is rendered based on the additional response 260) can include a first additional highlighted portion 2013A highlighting (e.g., by coloring, bolding, underlining, etc.) the first additional phrase of “Bernoulli numbers”, a second additional highlighted portion 2013B highlighting the second additional phrase of “integration by parts”, and a third additional highlighted portion 2013C highlighting the third additional phrase of “engineering problems”.

The first additional highlighted portion 2013A (e.g., the first additional phrase) can be selectable and be embedded with a first additional hyperlink which, when the first additional phrase is selected by a user (e.g., user R), causes a first additional follow-up query (“What are the fundamentals of the Bernoulli numbers?”) identified from the first additional anchor tag to be processed automatically (i.e., without additional user operation other than selecting the first additional highlighted portion 2013A) using the generative model (e.g., LLM 191). The second additional highlighted portion 2013B (e.g., the second additional phrase) can be selectable and be embedded with a second additional hyperlink which, when the second additional phrase is selected by a user (e.g., user R), causes a second additional follow-up query (“What is the method of integration by parts in calculus?”) that is identified from the second additional anchor tag to be processed automatically using the generative model (e.g., LLM 191). The third additional highlighted portion 2011C (e.g., the third additional phrase) can be selectable and be embedded with a third additional hyperlink which, when the third additional phrase is selected by a user (e.g., user R), causes a third additional follow-up query (“What are some engineering problems solved by the Bernoullis using calculus?”) that is included in the third additional anchor tag to be processed automatically using the generative model (e.g., LLM 191).

In various implementations, referring to FIG. 2C, a user may select (e.g., click) the second additional highlighted portion 2013B (e.g., the second key phrase of “calculus”) that is visually displayed via the user interface 200 of the client device 20. In response to receiving the user's selection of the second additional highlighted portion 2013B, the second additional follow-up query (e.g., “What is the method of integration by parts in calculus?”) can be provided to the LLM 191, for processing using the LLM 191.

In some implementations, the prompt generation engine (e.g., 1471 in FIG. 1A) can process the second additional follow-up query (e.g., “What is the method of integration by parts in calculus?”) to generate a further prompt. The further prompt can include the second additional follow-up query and/or the aforementioned complex instruction. For instance, the second additional follow-up query can be inserted in the aforementioned complex instruction, to generate the further prompt. The further prompt can be processed using the LLM 191, to generate a model output from which a further response 209 (in markup language) responsive to the further prompt can be derived.

As shown in FIG. 2C, the further response 209 (in markup language) can be, for instance, “<p> The method of integration by parts in calculus is a technique used for solving integrals that allows you to transform the integral of a product of two functions into simpler parts. Based on the formula <a href=“?query=What is the formula for integration by parts?”>∫udv=uv−∫vdu</a>, it's used when the integral is a product of ‘u’—the function to be differentiated and ‘dv’—the function to be integrated. Generally, this method is applied when the <a href=“?query=When is it appropriate to use the integration by parts method?”>integrand is a product</a> of two types of functions whose <a href=”? query=What is the integral and differential relationships in calculus? “>integral or differential is simpler </a>than the original function. </p>”. The further response 209 in markup language is not intended to be rendered visually or audibly, but is to be processed using the rendering engine (e.g., 102 in FIG. 1A). The further response 209 in markup language, when processed using the rendering engine 102, can be a further rendered response 290 having word content of “The method of integration by parts in calculus is a technique used for solving integrals that allows you to transform the integral of a product of two functions into simpler parts. Based on the formula ∫udv=uv−∫vdu, it's used when the integral is a product of ‘u’—the function to be differentiated and ‘dv’—the function to be integrated. Generally, this method is applied when the integrand is a product of two types of functions whose integral or differential is simpler than the original function.”

In the example of FIG. 2C, the further response 209 in markup language can include a first further anchor tag of <a href=“?query=What is the formula for integration by parts?”> for a first further phrase of “∫udv=uv−∫vdu”, and/or a second further anchor tag of <a href=“?query=When is it appropriate to use the integration by parts method?”> for a second further phrase of “integrand is a product”. Additionally, or alternatively, the further response 209 can include a third further anchor tag of <a href=“? query=What are the integral and differential relationships in calculus?”> for a third further phrase of “integral or differential is simpler”.

Correspondingly, the further rendered response 290 rendered based on the further response 209 can include a first further highlighted portion 2015A highlighting (e.g., by coloring, bolding, underlining, etc.) the first further phrase of “∫udv=uv−∫vdu”, a second further highlighted portion 2015B highlighting the second further phrase of “integrand is a product”, and a third further highlighted portion 2015C highlighting the third further phrase of “integral or differential is simpler”.

The first further highlighted portion 2015A (e.g., the first further phrase) can be selectable and be embedded with a first further hyperlink which, when the first further phrase (e.g., ∫udv=uv−∫vdu) is selected by a user (e.g., user R), causes a first further follow-up query (“What is the formula for integration by parts?”) identified from the first further anchor tag to be processed automatically (i.e., without further user operation other than selecting the first further highlighted portion 2015A) using the generative model (e.g., LLM 191). The second further highlighted portion 2015B (e.g., the second further phrase) can be selectable and be embedded with a second further hyperlink which, when the second further phrase (e.g., “integrand is a product” that is visually rendered) is selected by a user (e.g., user R), causes a second further follow-up query (“When is it appropriate to use the integration by parts method?”) that is identified from the second further anchor tag to be processed automatically using the generative model (e.g., LLM 191). The third further highlighted portion 2015C (e.g., the third further phrase) can be selectable and be embedded with a third further hyperlink which, when the third further phrase is selected by a user (e.g., user R), causes a third further follow-up query (“What are the integral and differential relationships in calculus?”) that is included in the third further anchor tag to be processed automatically using the generative model (e.g., LLM 191).

In some implementations, the user interfaces shown in FIGS. 2A˜2C can include content belonging to the same human-to-computer dialog. By using the LLM to generate a response (e.g., the response 250 in FIG. 2A) for an initial user query (e.g., 201 in FIG. 2A), highlight one or more portions (e.g., key phrases) in the response, and embed the one or more highlighted portions with a respective follow-up query that is selectable by a user, subsequent manual input from the user to provide follow-up queries (such as the aforementioned second follow-up query of “What contributions did Bernoulli make to calculus?” or the second additional follow-up query) is saved or reduced, resulting in an enhanced efficiency of user interaction between the user and an application that accesses the LLM.

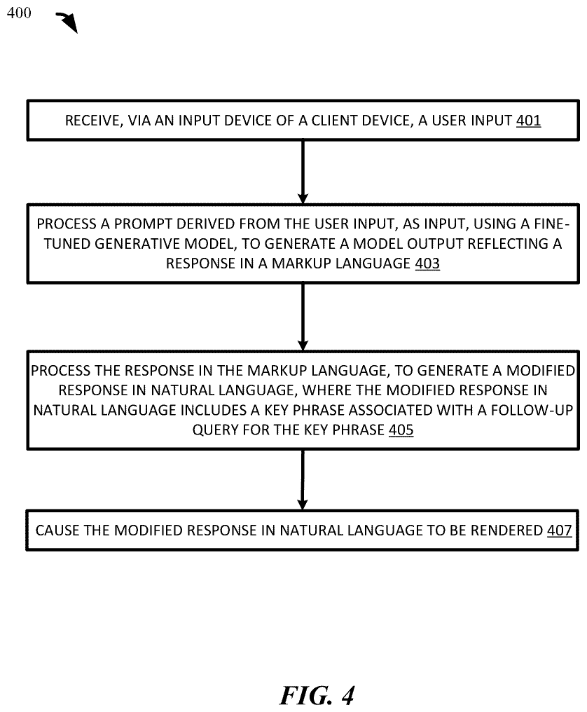

Turning now to FIG. 4, a flowchart illustrating an example scenario 400 of generating a response is provided, in accordance with various aspects of the present disclosure. A system for performing the method 400 includes one or more processors, memory, and/or other component(s) of computing device(s) (e.g., client computing device 10 of FIG. 1A, one or more servers such as 12 in FIG. 1A, and/or other computing devices). Moreover, while operations of the method 400 are shown in a particular order, this is not meant to be limiting. One or more operations may be reordered, omitted, and/or added. The system, for instance, can include a chat application (e.g., the LLM-based assistant 104 in FIG. 1A). The chat application having, or otherwise accesses, an LLM-based assistant as described above. The chat application can be installed at, or otherwise accessed via the client computing device 10 (e.g., laptop, stand-alone speaker, etc.) having one or more user input devices (e.g., microphone(s)) and/or one or more user output devices (e.g., speaker(s)).

In various implementations, at block 401, the system receives, via an input device of a client device, a user input. The user input, for instance, can be a typed input (an audible input, or other type of input) that initiates a human-to-computer dialog between a user of the user input and an application running (or being accessed via) the client device. As a working example, the user input can include a user query of “Who was Bernoulli?”.

In various implementations, at block 403, the system processes a prompt derived from the user input, as input, using a fine-tuned generative model, to generate a model output reflecting a response in a markup language. In some implementations, the response in the marked language can include a follow-up query (e.g., identified in a tag, such as an anchor tag “<a>”) determined for a key phrase that is present in the response. In some implementations, optionally, the response in the marked language can include more than one follow-up query each determined for a respective key phrase that is present in the response. In some implementations, the total number of the follow-up queries can be defined, for instance, in the prompt derived from the user input, and/or can depend on training instances that are applied to fine-tune the generative model.

The follow-up query (or a corresponding prompt derived from the follow-up query) can be processed using the fine-tuned generative model, to generate a follow-up response in the markup language. The follow-up response in the markup language (e.g., showing one or more additional follow-up queries) can be processed to generate a modified follow-up response in natural language (not showing, but is embedded with, the one or more additional follow-up queries). The modified follow-up response in natural language can be rendered visually in response to a user selecting (e.g., clicking) the key phrase in the modified response that is embedded with the follow-up query.

Continuing with the working example above, the prompt derived from the user query of “Who was Bernoulli?” can be, “Answer the question “{Who was Bernoulli?}” in no more than 3 sentences. Please format your answer in HTML code. Use <a href=“? query={QUERYTEXT}”>tags to highlight 2 sections that are most likely to be follow-up links. For each <a href=“?query={QUERYTEXT}>tag, replace {QUERYTEXT} with a follow-up question phrased as an inquisitive LLM prompt. Only include the reformatted answer in your response. Do not wrap your answer in quotes”. Correspondingly, the response in the markup language can be, for instance, “<p> The Bernoulli name refers to several prominent Swiss mathematicians of the 17^{th} and 18^{th} centuries, such as Jakob, Johann, and Daniel Bernoulli. They are known for their significant contributions to <a href=”?query=What contributions did Bernoulli make to calculus? “>calculus </a> and <a href=”? query=What is Bernoulli's principle? “>Bernoulli's principle</a> in fluid dynamics. </p>”

In the working example above, the response in the markup language can include a first follow-up query of “What contributions did Bernoulli make to calculus?” and a second follow-up query of “What is Bernoulli's principle?”. The first follow-up query (or a corresponding prompt derived therefrom) can be processed using the fine-tuned generative model, to generate a follow-up response in the markup language, e.g., “<p> The Bernoulli family made significant contributions to the field of calculus. Jacob Bernoulli, for instance, discovered the <a href=”?query=What are the fundamentals of the Bernoulli numbers? “>Bernoulli numbers</a>, a sequence of rational numbers that are deeply rooted in number theory. His brother, Johann Bernoulli developed the technique of <a href=”?query=What is the method of integration by parts in calculus? “>integration by parts </a> and both brothers applied their findings in solving engineering problems. </p>”. Such a follow-up response in the markup language can include a first additional follow-up prompt of “What are the fundamentals of the Bernoulli numbers?” and a second additional follow-up prompt of “What is the method of integration by parts in calculus?”.

In various implementations, at block 405, the system processes the response in the markup language, to generate a modified response in natural language. The modified response in natural language includes the key phrase, where the key phrase is embedded with the follow-up query determined using the fine-tuned generative model for the key phrase. For instance, continuing with the working example above, the modified response in natural language can be, “The Bernoulli name refers to several prominent Swiss mathematicians of the 17^{th} and 18^{th} centuries, such as Jakob, Johann, and Daniel Bernoulli. They are known for their significant contributions to calculus and Bernoulli's principle in fluid dynamics.”

In the working example above, the modified response in natural language can include a first key phrase of “calculus” and a second key phrase of “Bernoulli's principle”. The first key phrase of “calculus” can be highlighted in the modified response, and/or be associated with a first follow-up query of “What contributions did Bernoulli make to calculus?”. The first key phrase can be selectable, and when selected, causes the first follow-up query (e.g., “What contributions did Bernoulli make to calculus?”, or a prompt derived therefrom) to be processed, using the fine-tuned generative model, to generate a first follow-up response in markup language. The second key phrase of “Bernoulli's principle” can be highlighted in the modified response, and/or be associated with a second follow-up query of “What is Bernoulli's principle?” The second key phrase can be selectable, and when selected, causes the second follow-up query (e.g., “What is Bernoulli's principle?”, or a prompt derived therefrom) to be processed, using the fine-tuned generative model, to generate a second follow-up response in markup language.

In various implementations, at block 407, the system causes the modified response in natural language to be rendered via an output device (e.g., a display panel) of the client device (or a different device). As described above, the modified response in natural language can include at least the key phrase which is selectable, and when selected, causes a follow-up query (or a follow-up prompt that includes the follow-up query and a complex instruction as described elsewhere of this disclosure) to be processed using the fine-tuned generative model, to generate a corresponding follow-up response in the markup language. The follow-up response in the markup language can be processed to generate a modified follow-up response in natural language, where the modified follow-up response can be rendered visually via the output device.

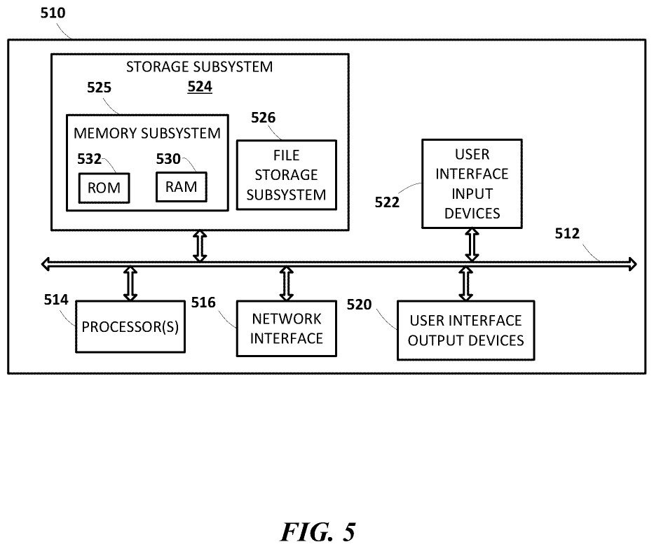

Turning now to FIG. 5, a block diagram of an example computing device 510 that may optionally be utilized to perform one or more aspects of techniques described herein is depicted. In some implementations, one or more of a client device, cloud-based LLM-based assistant 104 component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

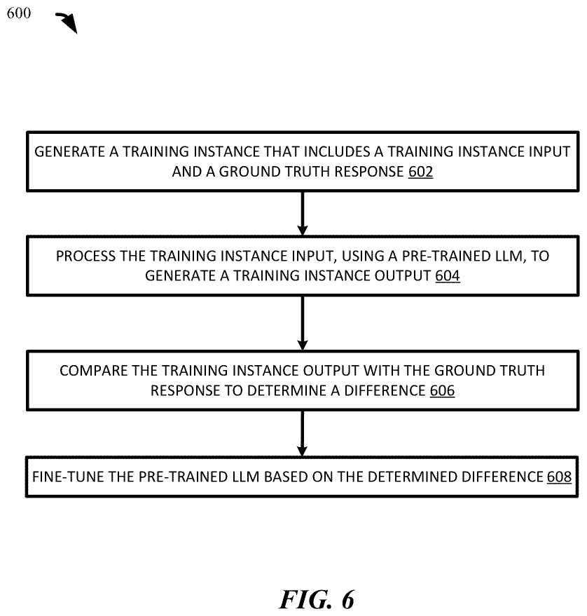

For example, turning now to FIG. 6, a flowchart illustrating an example method 400B of fine-tuning a pre-trained LLM is provided, in accordance with various aspects of the present disclosure. A system for performing the method 600 includes one or more processors, memory, and/or other component(s) of computing device(s) (e.g., client computing device 10 of FIG. 1A, one or more servers such as 12 in FIG. 1A, and/or other computing devices). Moreover, while operations of the method 600 are shown in a particular order, this is not meant to be limiting. One or more operations may be reordered, omitted, and/or added.

At block 602, the system generates a training instance that includes a training instance input and a ground truth response. The training instance input, for instance, can include noisy audio data capturing a user query. In some implementations, the system can generate more than one training instance (e.g., multiple training instances). Different training instances can include different noisy audio data as training instance input. The ground truth response can include, for instance, a response in markup language (e.g., HTML code, json, xml) having a predefined number of tags (e.g., anchor tags) each associated with a respective key phrase that is present in the response.

A non-limiting example of the training instance input can be (or can include), for instance, a user query of “how to change DNS settings on Acme router” recognized from the noisy audio data. Another non-limiting example of the training instance input can include the aforementioned complex instruction in addition to the user query, e.g., “Answer the question “{how to change DNS settings on Acme router}” in no more than 3 sentences. Please format your answer in HTML code. Use <a href=“? query={QUERYTEXT}”>tags to highlight a predefined number of sections that are most likely to be follow-up links. For each <a href=“?query={QUERYTEXT}>tag, replace {QUERYTEXT} with a follow-up question phrased as an inquisitive LLM prompt. The predefined number here is “1”. Only include the reformatted answer in your response. Do not wrap your answer in quotes.” A non-limiting example of the ground truth output that corresponds to the training instance input can be, for instance, “<p>First, type the router's <a href=”?query=What is an IP address?”>IP address </a> in a browser, the default IP address is 192.168.1.1. Then enter username and password, the defaults are admin and admin. Finally, select the advanced settings tab and find the DNS settings section. </p>”

At block 604, the system processes the training instance input, using a pre-trained LLM, to generate a training instance output. The pre-trained LLM can include millions of parameters or billions of parameters, and can be acquired based on pre-training an initial LLM using data from a diversity of sources such as webpages, published articles, etc.

At block 606, the system compares the training instance output with the ground truth response, to determine a difference between the training instance output and the ground truth response. At block 608, the system fine-tunes the pre-trained LLM based on the determined difference. For instance, the system can fine-tune one or more parameters of the pre-trained LLM based on the determined difference, to acquire a fine-tuned LLM that can be applied to generate responses in markup language, such as “205” in FIG. 2A, “206” in FIG. 2B, and “209” in FIG. 2C.

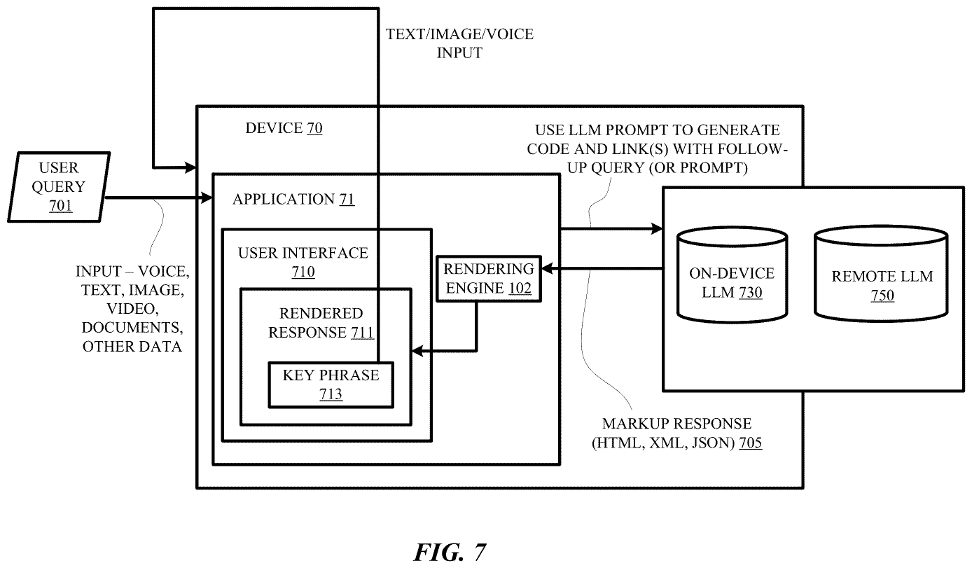

FIG. 7 depicts a flowchart illustrating a response generated using on device or remote LLM in accordance with various aspects of the present disclosure. As shown in FIG. 7, a user query 701 can be received via an application 71 (e.g., a chat application, or an automated assistant also referred to as “assistant application”, “chatbot”, “intelligent assistant”, etc.) that is installed at or accessible via a device 70. The user query 701 can include, or be determined from, voice input, textual input, image input, video input, one or more documents, or other data not specifically listed herein. In some implementations, content of the user query 701 can be visually rendered via a user interface 710 of the application 71. But this is not required.

In some implementations, an LLM prompt can be derived from the user query 701, and the LLM prompt can be processed using an on-device LLM 730 that is stored at the device 70 locally (and/or a remote LLM 750 that is stored at a server device), to generate a model output reflecting a response 705 for the user query 701 in a markup language such as HTML, XML, JSON, etc. The response 705 can be further processed and rendered using the rendering engine 102, as a rendered response 711 via the user interface 7h10 of the application 71. The rendered response 711 can include a key phrase 713 that is selectable, and when selected, causes a synthesized user query (which can include synthesized text, image, and/or voice inputs) to be received by the device 70, where the synthesized user query can be further provided to the on-device LLM 730 and/or Remote LLM 750, to generate a follow-up response for the synthesized user query. Specific examples and descriptions of the response 705, the rendered response 711, and various other elements illustrated in FIG. 7 can be found elsewhere in this disclosure, and repeated descriptions are omitted herein for the sake of brevity.

What is claimed is:

1. A method implemented using one or more processors, the method comprising:
receiving, via an input device of a client device, a user input;
processing a prompt derived from the user input, using a fine-tuned generative model, to generate a model output reflecting a response in a markup language, wherein the response in the markup language includes a follow-up prompt for a key phrase that is present in the response;
processing the response in the markup language to generate a modified response in natural language, wherein the key phrase in the modified response in natural language is selectable, and when selected, causes the follow-up prompt for the key phrase to be processed using the fine-tuned generative model; and
causing the modified response in natural language to be rendered via an output device.

2. The method of claim 1, further comprising:
in response to receiving the user input, generating the prompt that includes the user input and a complex instruction, wherein the complex instruction includes a first instruction that instructs to identify a phrase for follow-up interaction as the key phrase, and a second instruction that instructs to determine and associate the follow-up prompt with the key phrase.

3. The method of claim 1, wherein the modified response in natural language displays the key phrase but does not display the follow-up prompt for the key phrase.

4. The method of claim 3, wherein the key phrase is embedded with a link or a tag identifying the follow-up prompt for the key phrase.

5. The method of claim 1, wherein the key phrase includes a first entity identified from the user input.

6. The method of claim 1, wherein the key phrase includes a second entity identified in the response in the markup language but not identified in the user input.

7. The method of claim 1, further comprising:
receiving a user selection of the key phrase from the modified response in natural language; and
in response to receiving the user selection of the key phrase:
processing the follow-up prompt for the key phrase, using the fine-tuned generative model, to generate a follow-up model output reflecting a follow-up response in the markup language,
processing the follow-up response in the markup language, to generate a modified follow-up response in natural language, and
causing the modified follow-up response in the natural language to be rendered in response to the user selection of the key phrase in the modified response.

8. The method of claim 7, further comprising:
prior to receiving the user selection of the key phrase:
detecting a hover interaction with respect to the key phrase in the modified response rendered via the client device,
in response to detecting the hover interaction with respect to the key phrase, causing the follow-up prompt for the key phrase to be rendered visually until the hover interaction no longer exists.

9. The method of claim 1, wherein the response in the markup language includes an anchor tag having a href attribute that identifies the follow-up prompt for the key phrase.

10. A method implemented using one or more processors, the method comprising:
receiving, via an input device of a client device, a user input;
processing a prompt derived from the user input, using a fine-tuned generative model, to generate a model output reflecting a response in a markup language, wherein the response in the markup language includes a follow-up query for a key phrase that is present in the response;
processing the response in the markup language to generate a modified response in natural language, wherein the key phrase in the modified response in natural language is selectable, and when selected, causes the follow-up query for the key phrase to be processed using the fine-tuned generative model; and
causing the modified response in natural language to be rendered via an output device.

11. The method of claim 10, further comprising:
in response to receiving the user input, generating the prompt that includes the user input and a complex instruction, wherein the complex instruction includes a first instruction that instructs to identify a phrase for follow-up interaction as the key phrase, and a second instruction that instructs to determine and associate the follow-up query with the key phrase.

12. The method of claim 10, wherein the modified response in natural language displays the key phrase but does not display the follow-up query for the key phrase.

13. The method of claim 12, wherein the key phrase is embedded with a link or a tag identifying the follow-up query for the key phrase.

14. The method of claim 10, wherein the key phrase includes a first entity identified from the user input.

15. The method of claim 10, wherein the key phrase includes a second entity identified in the response in the markup language but not identified in the user input.

16. The method of claim 10, further comprising:
receiving a user selection of the key phrase from the modified response in natural language; and
in response to receiving the user selection of the key phrase:
processing the follow-up query for the key phrase, using the fine-tuned generative model, to generate a follow-up model output reflecting a follow-up response in the markup language,
processing the follow-up response in the markup language, to generate a modified follow-up response in natural language, and
causing the modified follow-up response in the natural language to be rendered in response to the user selection of the key phrase in the modified response.

17. The method of claim 16, further comprising:
prior to receiving the user selection of the key phrase:
detecting a hover interaction with respect to the key phrase in the modified response rendered via the client device,
in response to detecting the hover interaction with respect to the key phrase, causing the follow-up query for the key phrase to be rendered visually until the hover interaction no longer exists.

18. The method of claim 10, wherein the response in the markup language includes an anchor tag having a href attribute that identifies the follow-up query for the key phrase.

19. A system comprising one or more processors and memory storing instructions that, when executed, cause the one or more processors to:
receive, via an input device of a client device, a user input;
process a prompt derived from the user input, using a fine-tuned generative model, to generate a model output reflecting a response in a markup language, wherein the response in the markup language includes a follow-up query for a key phrase that is present in the response;
process the response in the markup language to generate a modified response in natural language, wherein the key phrase in the modified response in natural language is selectable, and when selected, causes the follow-up query for the key phrase to be processed using the fine-tuned generative model; and
cause the modified response in natural language to be rendered via an output device.

20. The system of claim 19, wherein the modified response in natural language displays the key phrase but does not display the follow-up prompt for the key phrase.
